(19) United States
(12) Patent Application Publication
(10) Pub. No.: US 2004/0050277 A1
(43) Pub. Date: Mar. 18, 2004

(54) Cleaning method and device for a printing roller

(76) Inventor: Herbert Stanka, Augsburg (DE)

Correspondence Address: OSTROLENK FABER GERB & SOFFEN, 1180 AVENUE OF THE AMERICAS, NEW YORK, NY, 100368403

(21) Appl. No.: 10/250,545

(22) PCT Filed: Nov. 5, 2002
(86) PCT No.: PCT/EP02/12318

(30) Foreign Application Priority Data
Nov. 6, 2001 (DE) 10153968.1

(51) Int. Cl. B41F 35/00

(52) U.S. Cl. 101/425

(57) ABSTRACT

Printing-press roll cleaning method and apparatus. Washing liquid is applied only to discrete longitudinal wetting zones (52) on a roll to be cleaned, leaving longitudinal non-wetting zones (54) between them. During the rotation of the rolls, the washing liquid flows away to the longitudinal non-wetting zones (54).

The invention relates to a printing-press roll cleaning method and a printing-press roll cleaning apparatus as claimed in the patent claims.

Accordingly, the invention relates to a printing-press roll cleaning method for cleaning rotating rolls in a roll train which contains a plurality of successive rolls resting on one another, comprising at least one driven roll and at least one non-driven roll, which can be driven only by peripheral surface contact with an adjacent roll, in particular inking unit rolls of an inking unit for offset printing, liquid being applied by machine to the peripheral surface of at least one of these rolls in order to loosen contamination, via discharge openings in a liquid application apparatus, which has a plurality of discharge openings distributed over the roll length, in addition the liquid being transferred from peripheral surface to peripheral surface of the rolls by the rotation of the rolls in the nip, and the liquid, together with the dirt loosened by it, in particular ink and paper dust, being wiped off on another of the rolls by a wiping apparatus.

Furthermore, the invention relates to a printing-press roll cleaning apparatus for cleaning rotating rolls in a roll train which contains a plurality of successive rolls resting on one another, comprising at least one driven roll and at least one non-driven roll which can be driven only by peripheral surface contact with an adjacent roll, in particular inking unit rolls of an inking unit for offset printing, the cleaning apparatus containing a liquid application apparatus with a plurality of discharge openings distributed over a roll length, through which liquid can be applied by machine to the peripheral surface of et least one of the rolls to loosen dirt, in particular ink and paper dust, the liquid being transferred from peripheral surface to peripheral surface in the nip by the rotation of the rolls and it being possible for the liquid, together with the dirt loosened by it, to be wiped off on another of the rolls by a wiping apparatus.

Prior Art:

Inking rolls of an inking unit in a printing unit for offset printing are wetted with liquid by means of what is known as a spray pipe in order to loosen the ink, said liquid being sprayed onto one of the rolls and doctored off on another roll. One or more of the inking unit rolls is/are driven, while other rolls are not driven, but are only co-rotated by the contact between their roll periphery and the roll periphery of an adjacent roll. The cleaning operation must be carried out in a short time in order to shorten the down times for printing operation. The liquid must therefore be transferred as quickly as possible and uniformly to all the rolls in the roll train from the roll which is wetted with the liquid from the spray pipe. If little liquid is sprayed onto the one roll, it takes a long time until all the rolls are wetted. If a great deal of liquid is sprayed onto the one roll, there is the risk that the liquid will back up in the nip or even upstream of the latter in the roll pocket and, as a result, will flow out of the roll train laterally in the roll longitudinal direction. Furthermore, there is the risk of overwetting the first or a plurality of following rolls in the roll train, so that the non-driven rolls, because of a lack of adhesive friction, are no longer co-rotated by the adjacent roll or stop and rotate in leaps and bounds and, in the process, throw off liquid mixed with loosened ink. The liquid, and therefore also the ink loosened by it, will no longer be transferred to the stationary roll and thus not transferred to the doctor apparatus of the doctored roll either. The inking unit will therefore no longer be cleaned adequately, so that it has to be cleaned manually.

The invention is intended to achieve the object of achieving reliable cleaning of all the rolls in a roll train in a short time in a simple and inexpensive manner.

According to the invention, this object is achieved by the defining features of claim 1 and of claim 7, respectively.

Claim 1 is defined by the fact that the liquid jets are applied only to individual narrow wetting zones corresponding to their width on the at least one roll, leaving non-wetting zones between them, the liquid being applied to the at least one roll in such a low quantity per unit time that the liquid only flows away laterally over the entire width of the non-wetting zones during a large number of roll revolutions, and, in the case of at least some of the rolls in the roll train following the one roll, in the nip of the rolls resting on one another, the liquid is initially likewise transferred only to wetting zones of the respective next roll, leaving non-wetting zones between them, and the liquid then flowing away laterally over the entire width of the non-wetting zones only after a plurality of roll revolutions, so that between the non-driven roll and the roll or rolls resting on it, a sufficient frictional resistance in order to drive it along in rotation is always ensured.

Claim 7 is defined by the fact that the discharge openings have an opening form and a distance from one another in the roll longitudinal direction such that the liquid jets, over their entire length and when they strike the at least one roll, have a spacing from one another in the roll longitudinal direction and, as a result, form individual wetting zones on the roll, corresponding to their jet width, leaving non-wetting zones between them, which no liquid jets strike.

Further features of the invention are contained in the subclaims.

### ADVANTAGES OF THE INVENTION

The invention ensures that the liquid is applied and distributed quickly in a short time to all the rolls up to and including the doctored roll. The invention prevents overwetting of rolls and, as a result, prevents non-driven rolls slipping or remaining stationary. Stationary rolls prevent the transfer of liquid to further rolls and, as a result, have the effect of backing up liquid in the roll pocket, from which liquid is then squeezed out laterally. The non-wetting zones ensure adequate adhesive friction between the rolls, by means of which all the non-driven rolls are co-rotated by adjacent rolls and no rolls slip because of overwetting of the adjacent roll. Furthermore, a rapid transfer of liquid to all the rolls is achieved. The invention uses substantially fewer discharge openings or nozzles than the prior art.

“Liquid” can be solvent, detergent, water containing detergent or solvent, water with one or more additives which influence the printing process, pure water or any other liquid. Furthermore, the type of liquid can be changed during the washing operation. For example, at the start, detergent or solvent or water containing one can be used to loosen ink from the rolls, and can be rinsed afterwards with clear water. “Rolls” also include press cylinders, but in particular inking unit rolls.

“Driven roll”: a roll can be driven by an electric motor, by a pneumatic motor or a hydraulic motor or by means of a drive connection from another roll or another cylinder in the press.

“Non-driven roll” is a roll which rotates only because it rests on an adjacent roll and is co-rotated by the latter by the frictional resistance.

“Point-like cross section of the liquid jets” means a jet with a small cross section and spacing from one another over the entire jet length from the nozzle as far as the point at which it strikes the roll, as opposed to a spray jet or a very wide flat jet, which touch one another or mix with one another as soon as they strike the roll or even previously.

“wiping apparatus” for wiping the liquid and the roll contamination possibly loosened by it: this can be a doctor, a brush or a cloth or another element with which the liquid and, if appropriate, dirt loosened by the latter, can be removed from a roll.

The invention will be described below with reference to the drawings and using preferred embodiments as examples. In the drawings:

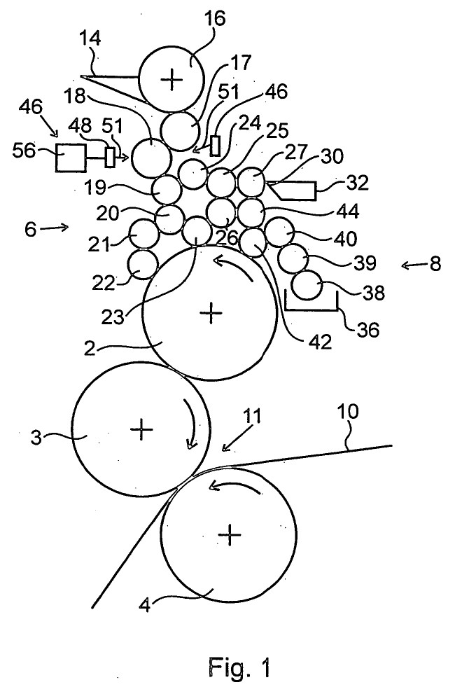

FIG. 1 shows, schematically, a side view of a printing unit with an inking unit and a damping unit,

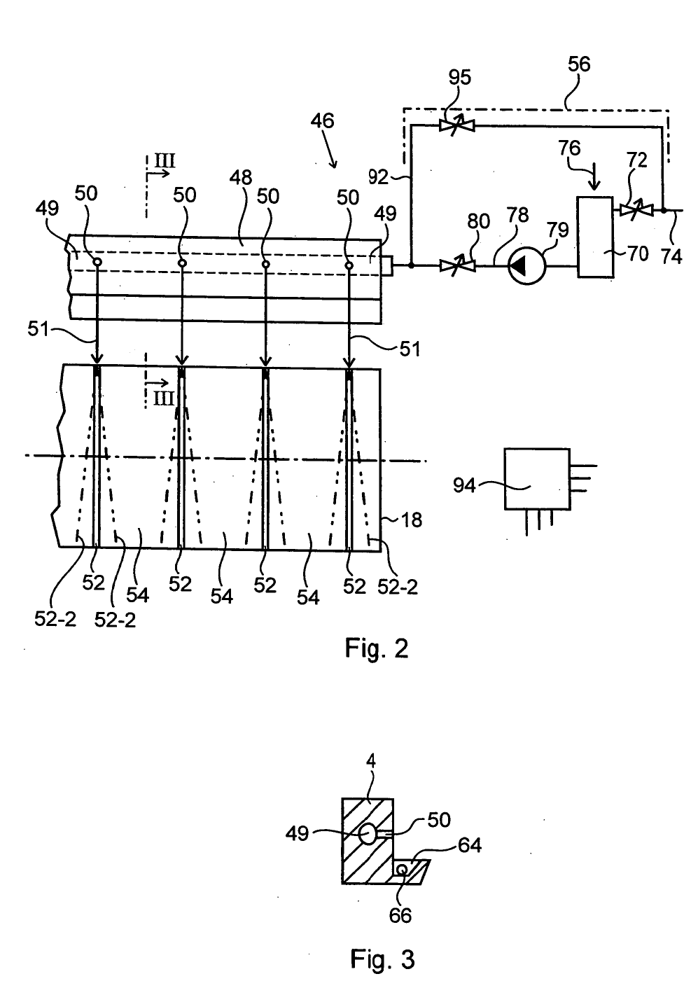

FIG. 2 shows, schematically, a plan view of a particular embodiment of the invention,

FIG. 3 shows a cross section along the plane III-III of a spray pipe from FIG. 2.

FIG. 1 shows, schematically and not to scale, a printing unit containing a plate cylinder 2, a blanket cylinder 3 contacting the latter, an impression cylinder 4 contacting said blanket cylinder 3, an inking unit 6 and a damping unit 8. This is therefore a damping-solution liquid offset printing unit. However, the invention can also be used for a dry offset printing unit. The printing unit can be part of a sheet-fed offset press (printing sheets) or a web-fed offset press (printing web-like printing material). The invention can also be used for other types of presses (relief printing, gravure printing).

The printing material 10 (sheet or web) runs through the nip 11 between the blanket cylinder 3 and the impression roll 4. The printing image is transferred from the plate cylinder 2 to the blanket cylinder and from the latter to the printing material 10.

The inking unit 6 can be of any desired type which contains at least one inking roll driven by a motor and at least one non-driven inking roll, the latter being driven by means of the frictional resistance of its peripheral surface with the peripheral surface of another roll.

The inking unit 6 of FIG. 1 contains, as an example, an inking fountain 14 and a roll train comprising inking rolls 16-27, of which one roll 16 is what is known as a ductor roll for picking up ink from the ink fountain 14, and of which at least one roll is driven by means of an electric motor, not shown, or another motor drive, and of which one or more rolls do not have any motor drive but only, by means of contact between their roll periphery with an adjacent roll, are driven by this adjacent roll, which can likewise be a roll without a motor drive.

A doctor 30 can be set against one of the inking rolls which is remote from the ductor roll 16, in order to doctor off ink and other contaminants from this roll 27, preferably into a holding trough 32.

The damping unit 8 contains a damping solution trough 36, from which, via a train of damping rolls 38, 39, 40 and 42, damping solution liquid is applied to the circumferential surface of the plate cylinder 2 in order to form ink-repelling regions in accordance with the printing image to be printed.

According to a particular embodiment, a transfer roll 44 or a plurality of transfer rolls can be provided, which on one side is in circumferential contact with a damping roll, for example damping roll 42, and on the other side is in circumferential contact with an inking roll, for example the inking rolls 26 and 27. By means of such a combination, at the start of a printing operation, an optimum printing condition can more quickly be achieved on the plate cylinder 2.

According to the invention, a printing unit roll cleaning apparatus 46 is provided for cleaning rotating rolls in a roll train, of which at least one roll can be driven by motor, for example the inking roll 17 after the ductor roll 16, and of which at least one roll, for example 19, can be driven only by contact between its peripheral surface and the peripheral surface of one of the other rolls, and of which at least one roll is an inking roll for transferring ink. According to the example of FIG. 1, all the inking rolls 16-27 of the inking unit 6 and the transfer roll 44 are to be washed.

The cleaning apparatus 46 contains a liquid application apparatus 48. This contains a distributor duct 49 having a large number of liquid discharge openings 50, which are positioned or can be positioned along a first of the rolls, for example the inking roll 18, which can be a motor-driven or a non-motor-driven roll, at a distance from said roll, in order to apply liquid to the peripheral surface of the roll 18. As a result of rotation of this roll 18, this liquid is transferred to the other rolls in peripheral contact with it and, from these rolls, also to further rolls in contact with them. The discharge openings 50 can be holes or nozzles inserted into holes.

“Liquid” can be solvent, detergent, water containing detergent or solvent, water with one or more additives which influence the printing process, pure water or any other liquid. Furthermore, the type of liquid can be changed during the washing operation. For example, at the start, detergent or solvent or water containing once can be used to loosen ink from the rolls, in order to be rinsed afterwards with clear water.

The liquid discharge openings 50 have a small size and shape, in such a way that liquid can be applied only to discrete longitudinal wetting zones 52 of this first roll 18, leaving longitudinal non-wetting zones 54 between them on this first roll 18. The width of a longitudinal wetting zone 52 is equal to the width of a liquid jet.

Furthermore, the cleaning apparatus 46 contains a liquid feed device 56 for feeding liquid to the discharge openings 50 and from the latter to the peripheral surface of the first roll 18 in such a quantity of liquid that, as a result of the rotation of the rolls, the liquid is transferred from the discrete wetting zones 52 of the first roll 18 to the peripheral surface of the further roll resting on its peripheral surface, the rolls 17 and 19 in the present example. As a result of the rotation of the rolls, the liquid is transferred from the longitudinal wetting zones 52 of the first roll 18 to longitudinal wetting zones lying opposite them on the at least one further roll 17 and 19, leaving longitudinal non-wetting zones thereon. In the same way, the liquid is transferred to discrete longitudinal wetting zones 52 from roll to roll to further rolls, to the rolls 19-27 in the present example.

The liquid flows away further out from roll to roll on the rotating rolls in the roll longitudinal direction over the longitudinal wetting zones 52, as illustrated schematically in FIG. 2 by “dot-dot-dash” lines 52-2.

In this way, with each roll revolution, the liquid is distributed more and more to the longitudinal non-wetting zones 54 and therefore to the entire length of all the rolls 16-27 and 44 to be cleaned.

The quantity of liquid per unit time from the discharge openings 50 can be constant or variable.

The liquid jets are to strike the roll “gently”. Therefore, they are preferably applied to the surface of the roll periphery in the form of an arcuate jet. FIG. 1 shows the liquid jets 51 only schematically.

FIG. 1 shows, on the left, an application apparatus 48 whose liquid jets 51 are aimed at the roll 18 and, on the right, a further application apparatus 48, which can be used alternatively or additionally, whose liquid jets 51 are aimed into the pocket between two rolls, for example the rolls 17 and 18.

According to a preferred embodiment of the invention, the liquid discharge openings 50 are designed to generate liquid jets 51 which have a point-like cross section from the discharge openings 50 as far as the roll 17 or 18.

At its lower end, the application apparatus 48 is preferably provided with a collecting trough 64 for collecting washing liquid that drips off, said trough 64 having a drain 66.

FIG. 2 shows a possible embodiment of a liquid feed device 56. Fresh water from a fresh water connection 74 can be fed to a detergent container 70 via a valve 72. If desired, an automatic feed device for detergent or solvent 76 into the detergent container 70 can be provided. From the detergent container 70, a line 78 which contains a pump 79 and a valve 80 goes to the distributor duct 49 of the liquid application apparatus 48. Furthermore, a fresh water feed line 92 which contains a valve 93 can be provided from the fresh water connection 74 to the distributor duct 82. Therefore, via all the discharge openings 50, firstly washing liquid containing detergent or solvent or, secondly, fresh water can be fed in as desired. According to other embodiments of the liquid feed device 56, only the feed of washing liquid containing detergent or solvent or only the feed of fresh water can be provided. The valves and pumps are controlled by means of an electronic control device 94, preferably as a function of a higher-order machine operating program belonging to the press.

The invention is not restricted to offset presses but can also be used for cleaning inking rolls in other types of press.

Instead of a doctor 30, another dirt wiping element can also be used, for example a cloth or a brush, which is placed on one of the rolls to be cleaned in order to wipe ink and washing liquid off it.

1. A printing-press roll cleaning method for cleaning rotating rolls (16-27, 38, 39, 40, 42, 44) in a roll train which contains a plurality of successive rolls resting on one another, comprising at least one driven roll and at least one non-driven roll, which can be driven only by peripheral surface contact with an adjacent roll, in particular inking unit rolls of an inking unit (6) for offset printing, liquid being applied by machine to the peripheral surface of at least one (17, 18) of these rolls in order to loosen contamination, via discharge openings (50) in a liquid application apparatus (48), which has a plurality of discharge openings (50) distributed over the roll length, in addition the liquid being transferred from peripheral surface to peripheral surface of the rolls by the rotation of the rolls in the nip, and the liquid, together with the dirt loosened by it, in particular ink and paper dust, being wiped off on another of the rolls by a wiping apparatus (30, 32), wherein the liquid jets (51) are applied only to individual narrow wetting zones (52) corresponding to their width on the at least one roll (18), leaving non-wetting zones (54) between them, the liquid being applied to the at least one roll in such a low quantity per unit time that the liquid only flows away laterally over the entire width of the non-wetting zones during a large number of roll revolutions, and, in the case of at least some of the rolls in the roll train following the one roll, in the nip of the rolls resting on one another, the liquid is initially likewise transferred only to wetting zones of the respective next roll, leaving non-wetting zones between them, and the liquid then flowing away laterally over the entire width of the non-wetting zones only after a plurality of roll revolutions, so that between the non-driven roll and the roll or rolls resting on it, a sufficient frictional resistance in order to drive it along in rotation is always ensured.

2. The printing-press roll cleaning method as claimed in claim 1, wherein the at least some of the rolls following the one roll (18) include the roll on which the liquid is wiped off.

3. The printing-press roll cleaning method as claimed in at least one of the preceding claims, wherein the wetting zones (52) on the at least one roll (18) are narrower than the non-wetting zones (54).

4. The printing-press roll cleaning method as claimed in at least one of the preceding claims, wherein the liquid jets (51) are sprayed into the pocket between the one roll (18) and a further roll (17) resting on it.

5. The printing-press roll cleaning method as claimed in at least one of the preceding claims, wherein the liquid jets (51) are aimed at the at least one roll (18) so as to fall in an arc, in order to achieve a soft landing thereon.

6. The printing-press roll cleaning method as claimed in at least one of the preceding claims, wherein the liquid jets (51) have a point-like cross section from the discharge openings (50) until they strike the at least one roll, in order to form narrow wetting zones (52) corresponding to their widths.

7. A printing-press roll cleaning apparatus for cleaning rotating rolls (16-27, 38, 39, 49, 42, 44) in a roll train which contains a plurality of successive rolls resting on one another, comprising at least one driven roll and at least one non-driven roll which can be driven only by peripheral surface contact with an adjacent roll, in particular inking unit rolls of an inking unit (6) for offset printing, the cleaning apparatus containing a liquid application apparatus (48) with a plurality of discharge openings (50) distributed over a roll length, through which liquid can be applied by machine to the peripheral surface of at least one of the rolls (17, 18) to loosen dirt, in particular ink and paper dust, the liquid being transferred from peripheral surface to peripheral surface in the nip by the rotation of the rolls and it being possible for the liquid, together with the dirt loosened by it, to be wiped off on another of the rolls by a wiping apparatus (30, 32), wherein the discharge openings (50) have an opening form and a distance from one another in the roll longitudinal direction such that the liquid jets (51), over their entire length and when they strike the at least one roll, have a spacing from one another in the roll longitudinal direction and, as a result, form individual wetting zones (52) on the roll, corresponding to their jet width, leaving non-wetting zones (54) between them, which no liquid jets strike.

8. The printing-press roll cleaning apparatus as claimed in claim 7, wherein the spacing of the discharge openings (50) from one another in the roll longitudinal direction is so great, and the liquid jet (51) produced by them on the roll surface is so narrow, that the non-wetting zones (54) lying between them on the rolls are wider than the wetting zones (52).

9. The printing-press roll cleaning apparatus as claimed in claim 7 or 8, wherein the discharge openings (50) aim the liquid jets (51) into the pocket between the one roll (18) and the further roll (17) resting on it.

10. The printing-press roll cleaning apparatus as claimed in at least one of claims 7 to 9, wherein the liquid jets (51) fall in an arc.

11. The printing-press roll cleaning apparatus as claimed in one of claims 7 to 10, wherein the liquid jets (51) have a point-like cross section when they strike the at least one roll.
